(19) United States
(12) Patent Application Publication
(10) Pub. No.: US 2010/0025052 A1
(43) Pub. Date: Feb. 4, 2010

(54) Arrangement for Preventing Fires

(76) Inventor: Hansjürg LEIBUNDGUT, Zurich (CH)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/512,130

(22) Filed: Jul. 30, 2009

(30) Foreign Application Priority Data
Jun. 30, 2008 (EP) 1196/08
Jul. 30, 2008 (CH) 1196/08

(51) Int. Cl. A62C 3/16; A62C 37/11

(52) U.S. Cl. 169/45; 169/60; 169/61; 169/91

(57) ABSTRACT

An arrangement for locally preventing the development of fires in closed duct systems or piping systems such as, in particular, cable ducts and ducts intended for transporting gaseous media, for locally containing the origin of fires, for extinguishing fires and also preventing fires from spreading, comprises at least one sensor (11) for detecting an increased temperature, increase in the content of CO₂ in the surrounding atmosphere, presence of low-temperature carbonization gases, etc. At least one container (13) containing an inert gas is further provided, the sensor being operatively connected in such a way to a releasing equipment disposed on the container that when a threshold value of one or more detected values has been exceeded, inert gas can be released from the container into the ambience.

### TECHNICAL FIELD

The present invention relates to an arrangement and a process for locally preventing the development of fires in closed duct systems or piping systems such as, in particular, cable ducts and ducts intended for transporting gaseous media, for locally containing the origin of fires, for extinguishing fires and also preventing fires from spreading and the use of the equipment and process of the invention.

### BACKGROUND AND SUMMARY

So-called cable fires can develop and spread further in piping systems intended for gaseous media such as air, in particular, and in closed duct systems such as cable ducts, in which usually electrical lines are also routed. These cable fires can spread over entire mains supply networks. In order to prevent the same, fire dampers or self-foaming fireproof bulkheads are usually installed at the borders of fire compartments. These fire dampers and fireproof bulkheads are intended to prevent the fire from flashing over from one fire compartment to another. An actual fire-extinguishing process in ducts and pipes is neither known from the prior art nor provided therein. The fire dampers and fireproof bulkheads cited above indeed restrict the consequences resulting from the occurrence of fires, but do not substantially reduce the development thereof.

It is therefore an object of the present invention to clearly reduce the risk of fires developing in piping systems intended for gaseous media, in particular, or in duct systems intended for routing lines, to locally contain fires in piping systems and to extinguish fires rapidly. The object underlying the invention is of relevance and interest if the piping system is permanently encased, for example, in concrete in the ground, and at the same time is used as a duct system for the electrical distribution system or if the duct system is part of a ceiling-element system. In doing so, electrical installations such as lighting systems or drives for exhaust air flaps are also integrated into exhaust air ducts by way of example.

The underlying object is achieved as suggested by the invention with the aid of an arrangement and a process pursuant to the invention as set forth herein. It has been suggested to install fire-control posts at several locations and at appropriate distances from each other in the chase or in the duct system, which fire-control posts are interconnected by way of an electrical cable, via which information is exchanged both among the different fire-control posts and with a superordinate monitoring system, and the individual fire-control posts are also supplied with active energy for triggering the desired function. All the fire-control posts preferably have an identical structure and, for example, four functions each: detecting, signaling, inerting, and sealing-off.

The functions of detecting and signaling are autonomous functions and each fire-control post performs the same independently of all the other posts. The functions of inerting and sealing-off are usually performed in most cases only in coordination with neighboring posts, with the superordinate control level or in an absolutely isolated case of emergency, if appropriate.

For performing the “detecting” function, each fire-control post is preferably equipped with at least one sensor that is suitable for detecting a developing or existing fire or appropriate fire conditions. For example, a temperature of more than 80°, the concentration of CO₂ in the surrounding atmosphere of more than 5,000 ppm, and the concentration of low-temperature carbonization gases are suitable indicators that by themselves or as a sensor system enable the detection of a dangerous situation. The energy for operating the sensors is obtained from an electrical cable that either interconnects the fire-control posts or that forms part of an electrical piping system which is laid in the chase or cable duct anyway. During normal operation, that is to say, in the case of measured values lying below a threshold value or the tolerance limit, the sensor usually either does not transmit any so-called “Ready” signals or transmits only sporadic “Ready” signals. If the sensor value/s at a fire-control post exceed a defined threshold value also referred to as alarm value 1, a rapid signaling mode is started and the current sensor values are signaled at least to a superordinate location or preferably also to all the fire-control posts in the duct system or in the signaling network. Usually, no further functions of the fire-control post are triggered if only one threshold value or alarm value 1 at only one post has been exceeded.

If the sensor values at a fire-control post exceed the alarm value or defined threshold value and if the system signals that other fire-control posts have also measured the exceedance of an alarm value 1 or a threshold value, then the “inerting” function can be triggered at one or more fire-control posts. In doing so, a quantity of inert gas is released in or at the fire-control post by opening a container in which the inert gas is stored under pressure during normal operation. The inert gas flows in all directions of the duct system away from the fire-control post and reduces the content of oxygen in the duct behind the inert gas front to, for example, <12%, that is to say, below the flammability limit. In this zone, fire either cannot develop or it is extinguished. Simultaneously with the triggering of the “inerting” function, mechanical shutters in the duct system can be closed and an alarm can additionally be triggered with the specification of the activated fire-control posts, by virtue of which the electric supply into the electrical cables within the duct system is interrupted with the exception of the power supply to the monitoring system.

Should the sensor values continue to rise at at least one, preferably at least two neighboring fire-control posts in the system after the “inerting” phase has been triggered, the “sealing-off” function is triggered. In doing so, an additional container is opened in which a suitable substance is stored under the pressure of a second inert gas or propellant, which substance rapidly foams up after the container has been opened and completely seals the entire cross-section of the duct at the location of the fire-control post(s) and renders the same fireproof. The excess inert gas and propellant can flow further into the duct and perform a second inerting function. Together with the triggering of the “sealing-off” function, a fire alarm is set off and the activated fire-control posts are displayed. By means of the superordinate monitoring system, a damage profile and a threat level can be calculated from the signals received and additional precautionary measures are activated at other systems of building maintenance management. These precautionary measures can include:
switching off the conveyance of supply air and closing inlet air flaps
alarming the zones and triggering evacuation
closing exhaust air flaps to the room
introducing additional suitable measures, by way of example.

The system can be operated, for example, using the so-called digitalSTROM™ technology of AIZO AG, a corporation of the Federal Republic of Germany, the normal power grid or also a separate wire possibly in addition to a normal supply with a voltage of, for example, 230 Volts AC being laid for the electrical supply of the fire-control posts. The fire-control posts are connected electrically by means of this separate wire. This results in higher redundancy. Should there be a power loss on this wire, the “switch-off” function is triggered after a short period of time.

Incidentally, the use of the digitalSTROM™ technology means that it is possible to exchange information over the entire wire and transport active power to the fire-control post.

### BRIEF DESCRIPTION OF DRAWINGS

The invention is explained in further detail by way of example and with reference to the accompanying Figures, in which:

FIG. 1 shows the cross-section of a duct, for example, that is suitable for transporting a gaseous medium and additionally containing electrical lines and a monitoring post of the invention, and

FIG. 2 schematically shows the longitudinal section of the duct from FIG. 1, where the region of the monitoring post in the duct has been sealed off by means of foam.

### DETAILED DESCRIPTION

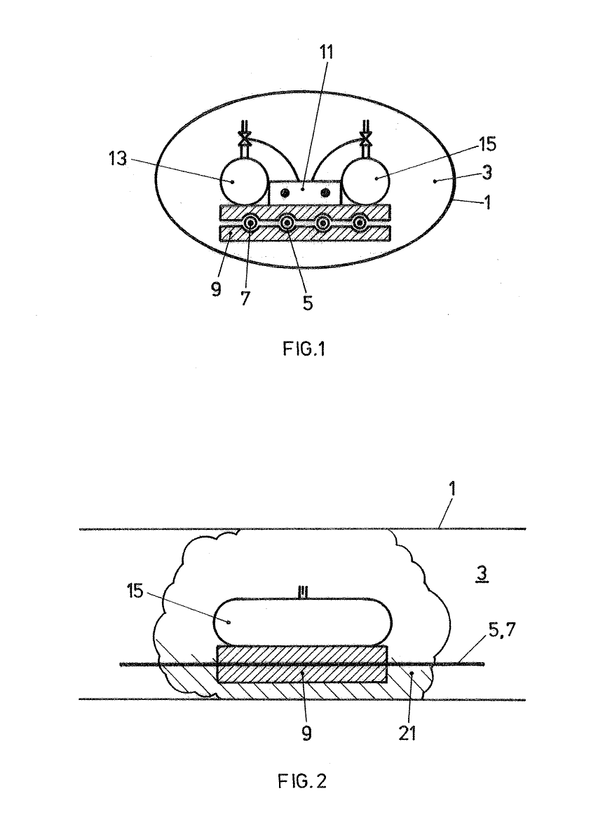

FIG. 1 shows the cross-section of a duct 1 intended, for example, for transporting a gaseous medium such as exhaust air or supply air into a ventilation system. Additional lines 5 such as electrical lines intended for the feed of a lighting system or ventilation systems, etc. are routed in the interior 3 of the duct, in which the exhaust air is conveyed. In addition to the electrical lines 5, an electrical connecting cable 7 can be provided for feeding the monitoring system provided in accordance with the invention. For preventing the spread of fires or for determining the development of fires, this monitoring system comprises a plurality of sensors that are distributed over the duct system, one sensor 11 being illustrated schematically in FIG. 1 to represent the plurality of sensors and this sensor 11 being supplied with power, for example, from the electrical connecting cable 7 via an electrical connecting terminal 9. However, it is also possible to supply the sensor 11 with power directly from the electrical cable 5.

Furthermore, two containers 13 and 15 are disposed on the monitoring post as shown schematically in FIG. 1, an inert gas A being contained in container 13 while container 15 contains a propellant and a foaming material B.

The monitoring station shown schematically in FIG. 1 can be part of a comprehensive sensor system comprising a plurality of monitoring stations similar to the one illustrated in FIG. 1. The different monitoring stations can be interconnected via the electrical connecting cable 7 in addition to the line 5, it being possible for a data exchange to take place in both cases, together with the electrical power supply, among the different monitoring stations and with a superordinate control station by means of the so-called digitalSTROM™ technology.

If the sensor 11 at a monitoring station illustrated in FIG. 1 detects an increase in the ambient temperature or an increase in the CO₂ content or the presence of low-temperature carbonization gases, an alarm can be triggered usually when defined threshold values have been exceeded. This alarm, also referred to as alarm value 1, is transmitted both to the other monitoring stations and also a superordinate control center. If additional stations detect that the threshold values have been exceeded, then as described above, the “inerting” function is triggered, the sensor triggering the release of the inert gas [A] contained in container 13. An inerting function of such type can also be performed at only one monitoring station and also only if the threshold values at this station have been exceeded. The operation of the monitoring system naturally depends on the type of duct system or piping system and the amount of distance between the different monitoring stations or sensors.

By releasing the inert gas, the oxygen content in the surroundings of the sensor 11 within the duct 1 is reduced to a value in a manner that disables additional fires from developing or enables an existing fire to be quenched. However, if the threshold values have been exceeded at several stations and an inerting function also cannot extinguish a fire sufficiently or cannot extinguish a fire at all, which in turn can be detected by the sensor 11, for example, the release of the propellant and the foaming agent contained in container 15 is triggered, which is illustrated schematically in FIG. 2. It is apparent from FIG. 2 that the duct 1 is completely filled out in the region of the monitoring station by the release of the propellant and the foaming material, by virtue of which a sealing-off effect is achieved in the duct 1 by filling out the duct interior as shown schematically at 21. By the release of foam at different stations, for example, a fire can be quenched in all probability, by virtue of which it is possible to effectively prevent the fire from spreading further.

If a sealing-off by means of foam is necessary, a corresponding alarm is additionally triggered and passed to the central monitoring station so that it is now possible to determine the location at which the duct system has been sealed-off with the aid of foam.

As described above, but not illustrated in the Figures, it is also possible to provide mechanical shutters in the duct system in order to divide the duct into different fire compartments for preventing a fire from spreading.

The monitoring station illustrated in FIGS. 1 and 2 and comprising sensor 11 is naturally only an example for promoting a better understanding of the present invention. Thus, it need not be a ventilation system, instead it can be any closed duct suitable for transporting a gaseous medium, for example. In general, piping systems, cable ducts, etc. can also be equipped with the monitoring system suggested by the present invention in order to detect possible fires and effectively prevent the fire from spreading or efficiently extinguish a fire, if appropriate.

Also the duct 1 need not have an oval cross-section, as illustrated; a rectangular, round, or square cross-section is also possible.

1.-14. (canceled)

15. Arrangement for locally preventing the development of fires in closed duct systems or piping systems including cable ducts and ducts intended for transporting gaseous media, for locally containing the origin of fires, for extinguishing fires and also preventing fires from spreading, the arrangement comprising:
at least one sensor for detecting at least one of an increased temperature, increase in the CO₂ content in the surrounding atmosphere, and presence of low-temperature carbonization gases, within a closed system and
at least one container containing an inert gas and having a releasing equipment disposed on the container, the sensor being operatively connected to the releasing equipment such that when a threshold value of one or more detected values has been exceeded, inert gas can be released from the container into the ambience within the closed system.

16. Arrangement according to claim 15, wherein the arrangement is provided in a closed duct system, the arrangement further including several sensors provided at a distance from each other in the duct system, wherein the sensors are connected to a monitoring system for the exchange of information such that when a sensor detects that a threshold value has been exceeded, the corresponding sensor can be located and, if appropriate, data can be transmitted or exchanged between the different sensors.

17. Arrangement according to claim 16, further comprising a power supply that is separate from the remaining lines is provided in the duct system and that a data exchange between the sensors and/or a monitoring station is carried out with the aid of means for simultaneous data exchange taking place between the sensors and the monitoring station in the line carrying electrical current for the power supply.

18. Arrangement according to claim 15, wherein the arrangement is provided in a closed duct system, the arrangement further including an additional container which contains a foaming material and has a releasing equipment disposed on the additional container, the releasing equipment being operatively connected to the sensor and the foaming material being releasable when the sensor detects that a threshold value has been exceeded in order to foam or seal-off a local region in the duct system.

19. Arrangement according to claim 15, wherein the arrangement is provided in a closed duct system, the arrangement further including fire dampers provided in the duct system in order to separate local regions of the system from each other in the case of a fire.

20. Arrangement according to claim 15, wherein the arrangement is provided in a closed duct system, the arrangement further including an electrical power line in the duct system for feeding electrical power to the at least one sensor and the releasing equipment, connecting terminals with an electrical connection for power supply being provided in the region of each sensor.

21. Monitoring system for preventing the development of fires in duct systems or piping systems, for locally containing the origin of fires, for extinguishing fires and also preventing fires from spreading, the monitoring system comprising one or more arrangements according to claim 15.

22. Process for locally preventing the development of fires in closed duct systems or piping systems including cable ducts and ducts intended for transporting gaseous media, for locally containing the origin of fires, for extinguishing fires and also preventing fires from spreading, the process comprising:
detecting at least one of an increased temperature, rise in the concentration of CO₂, and presence of low-temperature carbonization gases, with the aid of at least one sensor disposed within a duct, and when by said detecting a threshold value has been exceeded, triggering a local inerting of the duct at least in the region of the sensor by releasing an inert gas.

23. Process according to claim 22, wherein at least one of an increased temperature, a rise in the concentration of CO₂, and presence of low-temperature carbonization gases can be detected locally by means of each of several sensors disposed at a distance from each other in the duct system, and when by said detecting a threshold value has been exceeded at at least two of the sensors, triggering a local inerting of the duct in the region of at least one of the sensors by releasing an inert gas.

24. Process according to claim 22, wherein a container containing an inert gas under pressure is disposed locally in the region of each sensor, release of the inert gas from the container being triggered when the sensor detects that a threshold value has been exceeded.

25. Process according to claim 22, including providing mechanical shutters in the duct system which close when the sensor detects that the threshold values have been exceeded at several stations in order to separate different compartments of the duct system from each other.

26. Process according to claim 22, wherein when at least one sensor continues to detect that the threshold values have been exceeded, triggering the release of a foaming agent in the duct in order to completely seal-off the region of the respective sensor in the duct system.

27. Use of the equipment according to claim 15, for preventing the development of fires or for containing the origin of fires and preventing fires from spreading in ventilation ducts and in ventilation systems.

28. Use of the equipment according to claim 15, for preventing the development of fires or for containing the origin of fires and preventing fires from spreading in cable duct systems intended for routing electrical lines in a duct system.
